(19) United States
(12) Patent Application Publication
(10) Pub. No.: US 2001/0030534 A1
(43) Pub. Date: Oct. 18, 2001

(54) Rotation angle sensor

(76) Inventor: Peter Apel, Sudkirchen (DE)

Correspondence Address: SKJERVEN MORRILL MACPHERSON LLP, Suite 300W, 9600 Great Hills Trail, Austin, TX, 78759, US

(21) Appl. No.: 09/788,630

(22) Filed: Feb. 15, 2001

(30) Foreign Application Priority Data
Feb. 15, 2000 (DE) 200 02 719.0
Feb. 28, 2000 (DE) 200 03 512.6

(51) Int. Cl. G01B 7/30

(52) U.S. Cl. 324/207.2; 324/207.25

(57) ABSTRACT

A rotation angle sensor for use in a throttle adjustment device is disclosed, which includes a stator unit having at least two stator part elements positioned relative to each other leaving a spacer recess therebetween; a Hall sensor positioned in the spacer recess; a rotor unit having a magnetic element having a connector element molded into the rotor unit; a plug unit; and a housing unit adapted to partially house the stator unit.

### BACKGROUND OF THE INVENTION

The instant application claims priority to pending German Patent Applications 200 02 719.0 filed Feb. 15, 2000 and 200 03 512.6 filed Feb. 28, 2000, both of which are incorporated by reference herein in their entirety.

### FIELD OF THE INVENTION

The present invention relates to rotation angle sensors.

### DESCRIPTION OF THE RELATED ART

Rotation angle sensors, especially for throttle adjustment devices, are known. These sensors have at least a stator unit having at least two stator part elements arranged relative to each other, leaving a spacer recess in which at least one Hall sensor is positioned, a rotor unit having at least one magnetic element movable relative to the stator unit, a plug unit and a housing unit, in which at least the stator is at least partially housed.

A rotation angle sensor for a throttle adjustment device of the type just mentioned is known from WO 9 514 911 A1. A throttle is arranged to rotate with a throttle shaft in a closed throttle housing. The rotation angle sensor is connected to the throttle shaft and consists of a stationary and a rotating unit. A Hall element is arranged between two stator part elements of the stationary unit. The rotating unit has an annular magnet that can be moved around the stator element.

The rotation angle sensor is arranged in a housing recess and is mounted separately from the outside on the throttle housing. If a motor unit and gear unit are used as drive unit, these are accommodated, together with the rotation angle sensor and a circuit unit, simply in an actuator housing. The actuator housing is then also plugged in. In both cases, it is visible from the exterior that the throttle housing is equipped with additional parts.

DE 199 03 490 A1 modifies a rotation angle sensor, so that both the stationary and rotating unit are accommodated in a cover element. The cover element can also accept a gear mechanism of the throttle adjustment unit. The housing of the throttle adjustment unit can be closed by means of the cover element so equipped.

The magnetic element and the stator part elements are designed segmented in DE 299 09 201 U1 and DE 299 08 409 U1. It is proposed for better positioning of these segments to mold the stator segments either into a cover element or housing element and to form at least the magnetic segment in the gear of a gear mechanism, although it is not stated how this molding is to occur. A rotation angle sensor, in which the stator elements and magnetic element are designed as partial annular segments, is known from WO 98 55 828 A1 (FR 27 64 372 A1).

The material expense for these parts is certainly reduced because of this, but the manufacturing and assembly expense are still too high.

It is known from U.S. Pat. No. 4,948,277 to embed a ring having a number of teeth in a plastic element. However, embedding is only carried out to seal off the rotor of a coder. These and other drawbacks are known in the prior art.

### SUMMARY OF THE INVENTION

In an example embodiment, a rotation angle sensor for use in a throttle adjustment device includes a stator unit having at least two stator part elements positioned relative to each other leaving a spacer recess therebetween; a Hall sensor positioned in the spacer recess; a rotor unit having a magnetic element having a connector element molded into the rotor unit; a plug unit; and a housing unit adapted to partially house the stator unit.

In another embodiment, the rotation angle sensor may include a stator unit having at least two stator part elements each having a connector element, positioned relative to each other leaving a spacer recess therebetween; at least one Hall sensor positioned in the spacer recess; a rotor unit with at least one annular magnetic part element; a plug unit connected to the Hall sensor by a pressed screen; and a housing unit adapted to at least partially house the stator unit, wherein at least the connector elements of thestator part elements and the pressed screen are at least partially molded into the housing element.

In yet another embodiment, a rotation angle sensor as discussed above may include a a housing unit in which at least the stator unit is at least partially housed, and the annular magnetic part element has a connector element positioned with the magnetic segment in said rotor unit. In a further embodiment, a rotation angle sensor for use in a throttle adjustment device may include a stator unit having at least two stator part elements positioned relative to each other leaving a spacer recess therebetween; a Hall sensor positioned in the spacer recess; a rotor unit having at least one annular magnetic part element, and movable relative to said stator unit, wherein the magnetic part element has at least one magnetic segment with at least one flux conductor sheet thereon; a plug unit; and a housing unit in which at least the stator unit is at least partially housed.

In another embodiment, a rotation angle sensor with a rotor unit having at least one annular magnetic part element having at least one magnetic segment having a connector element, in which the magnetic part element is molded at least with the connector element into the rotor unit. Furthermore, connector elements of the stator part elements and a pressed screen are at least partially molded into the housing unit.

In another embodiment, a rotation angle sensor includes a rotor unit having an annular magnetic part element having at least one magnetic segment with at least one flux conductor sheet located thereon, in which the magnetic segment and the flux conductor sheet are molded at least partially into the rotor unit.

### BRIEF DESCRIPTION OF THE DRAWINGS

The present invention may be better understood, and its numerous objects, features, and advantages made apparent to those skilled in the art by referencing the accompanying drawings.

FIG. 1a shows a first variant of a rotation angle sensor in a schematic perspective view,

FIG. 1b shows a stator unit of a rotation angle sensor according to FIG. 1a, with a first variant of a pressed screen in a schematically depicted top view,

FIG. 2 shows a section through a stator unit according to FIG. 1b along line A-A,

FIG. 3 shows a stator unit of a rotation angle sensor according to FIG. 1a, with a second variant of a pressed screen in a schematically depicted top view,

FIG. 4 shows a section through a rotation angle sensor according to FIG. 3 along line C-C,

FIGS. 5a to 5d shows a stator segment with differently designed connectors, shown in enlarged sectional views of a section through a rotation angle sensor according to FIGS. 1 and 3 along line B-B,

FIG. 6 shows a second variant of a rotation angle sensor with a third variant of a pressed screen in a schematically depicted top view,

FIG. 7 shows a section through a rotation angle sensor according to FIG. 6 along line VII-VII,

FIG. 8a shows a second variant of a rotation angle sensor with a fourth variant of a pressed screen in a schematically depicted top view,

FIG. 8b shows a section for a rotation angle sensor according to FIG. 8 along line IX-IX,

FIG. 9 shows an enlarged partial cutout of a rotation angle sensor according to FIG. 1a with a rotor unit in a schematic top view,

FIGS. 10a to 10f shows a rotor unit according to FIG. 9 for a rotation angle sensor according to FIGS. 1 to 5d with differently designed annular magnetic part elements in a schematically depicted partial top view,

FIGS. 11a to 11f shows a section through a rotor according to FIGS. 10a to 10f along line XI A-XI A to line XI F-XI F,

FIGS. 12a to 12f shows a cutout X from a cross sectional view according to FIGS. 11a to 11f.

The use of the same reference symbols in different drawings indicates similar or identical items.

### DESCRIPTION OF THE PREFERRED EMBODIMENTS

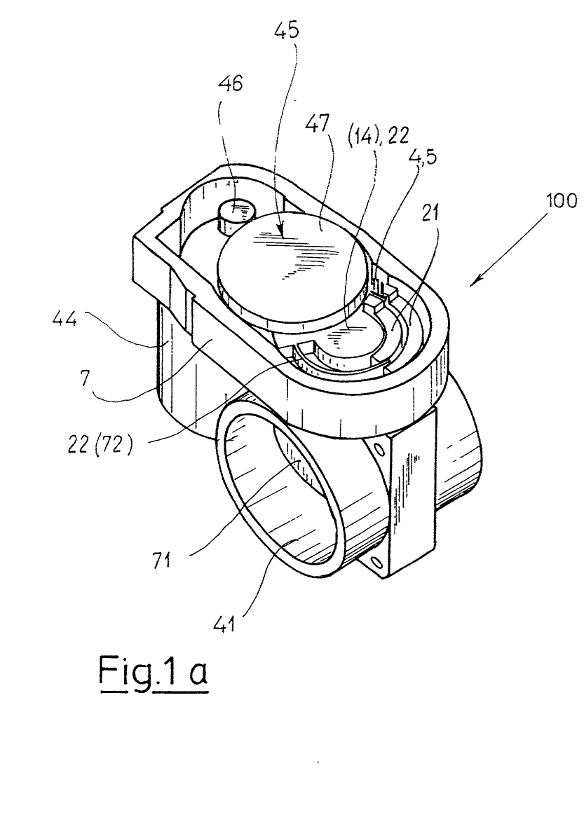

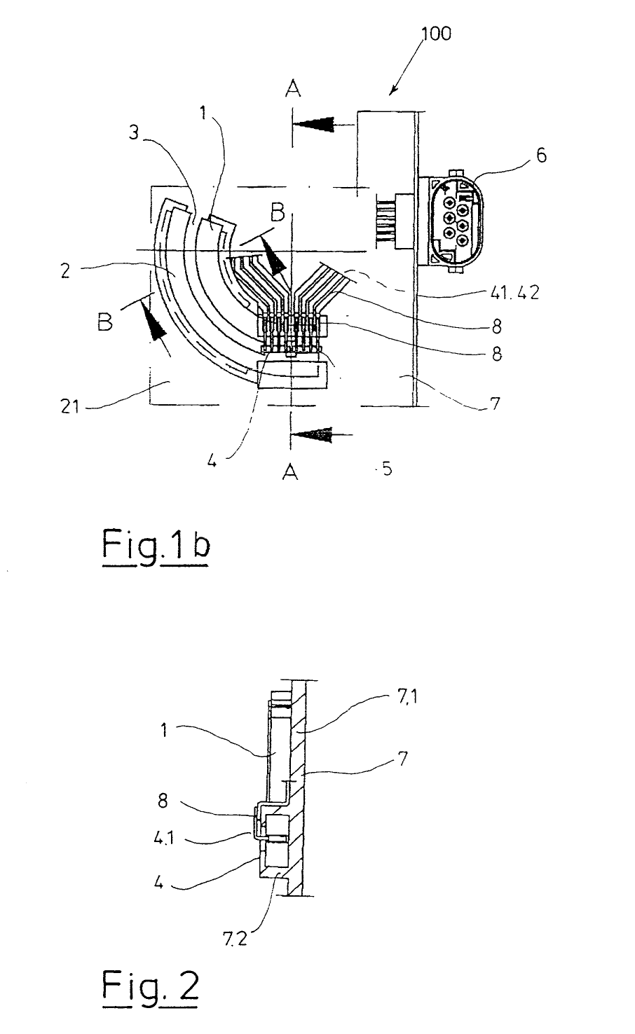

A throttle rotation angle sensor 100 is depicted in FIG. 1a. It includes a throttle unit having a throttle housing 41 and a throttle 71 adjustably arranged in the throttle housing 41 via a throttle shaft. A cover element 7 carrying a motor 44 is arranged on the throttle housing 41. The cover element 7 may be manufactured as a closed formation. It may also be manufactured as an open configuration, which is then closed with a separate cover.

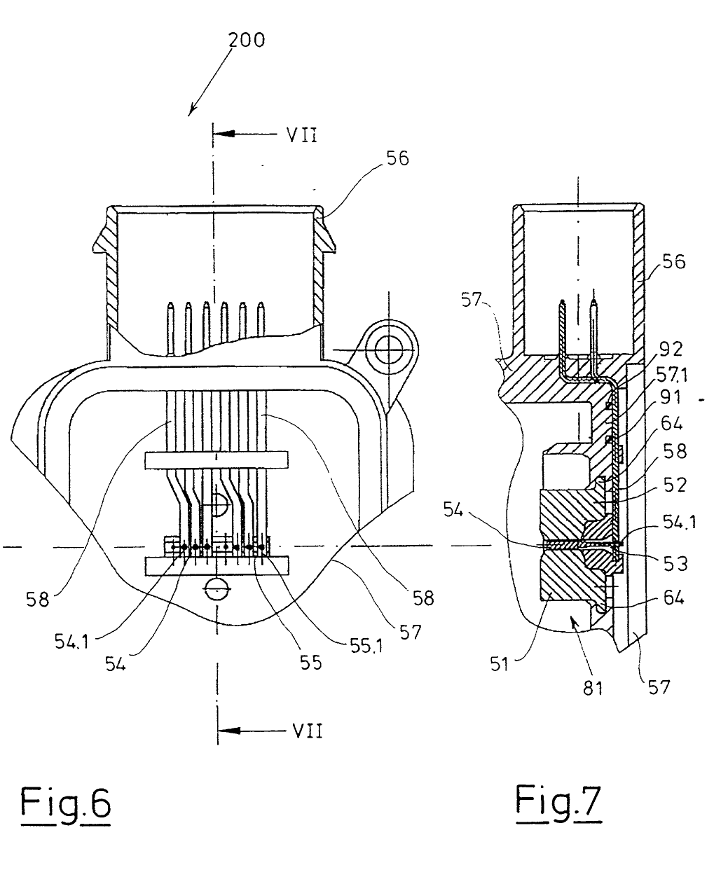

As further shown in FIG. 1a, a gear mechanism 45, a stator unit 21 and a rotor unit 22 of a Hall effect rotation angle sensor device are arranged in cover element 7. The gear mechanism 45 may be designed as an ordinary gear mechanism or as a planetary gear mechanism. In an example embodiment, it may include a motor pinion 46, which is connected to the shaft of motor 44. The motor pinion 46 operates together with an intermediate pinion 47, on whose bottom (cf. also FIG. 6) an adjustment pinion 48 is arranged. The adjustment pinion 48 again operates with a gear 22 designed as a gear segment, which is connected or connectable to the throttle shaft.

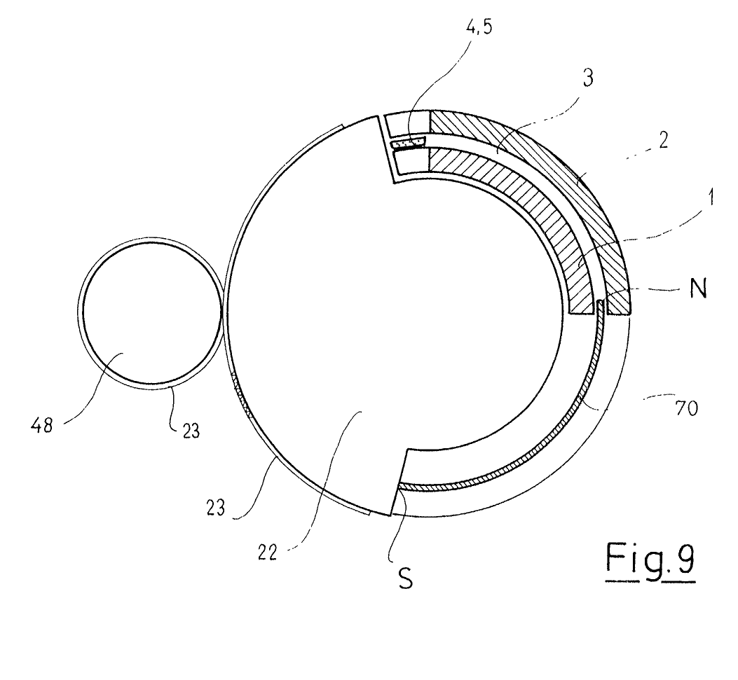

The configuration of the stationary and moving units is an important aspect of the invention. As shown in FIG. 9, the stationary unit is formed by two opposite stator part segments 1, 2. The stator part segments 1,2 may be held in housing element 7. An air gap 15, which is simultaneously also a stator spacing recess 3, on whose end one or two Hall sensors (ASIC) 4,5 are arranged, is situated between the two stator segments.

The gear segment 22 operates on about ⅓ of its periphery, together with the adjustment pinion 48, both gears having toothing 23. The gear segment 22 is connected to a spring secured in cover element 7. This guarantees that the gear segment 22 is always rotated into a defined end position. Rotation of gear segment 22 into the prescribed end position ensures that the throttle rotation angle sensor 100 also assumes a defined end position. A shaft sealing ring 72 is arranged at least between gear segment 22 and cover element 7 for sealing purposes.

A semicircular additional segment lies opposite the toothed segment of gear segment 22, which is spaced relative to stator part segment 1. A partial annular magnetic part element 70 is molded on one side of this segment as a rotating unit. Owing to the fact that the gear segment 22 may be plastic, the partial circular annular magnetic part element 70 should be shaped true to position and precisely. During rotation of gear segment 22, the annular magnetic part element 70 travels like a sickle in the spacer recess 3 and thus produces a variable Hall voltage value.

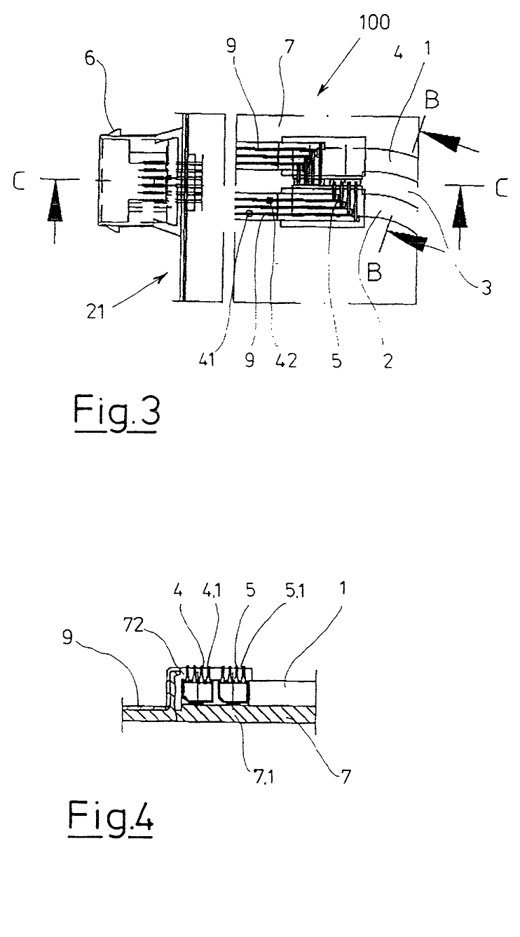

The stator unit 21 of the rotation angle sensor with the stator segment 1 and the stator segment 2, which are arranged relative to each other, thus creating the spacer recess 3, are shown in detail in FIGS. 1b and 3.

In an example embodiment, the stator segments may be designed as pitch circles. The pitch circle may have an angle between about 80° and 180°. As a result of longer experiments, it was found that a quarter pitch circle of 115° generates the most accurate measured values. The two opposite sickle-like configurations of stator segments 1,2 result from this.

A Hall sensor 4 and a Hall sensor 5 may be arranged on one end of the opposite stator segments in the spacer recess 3. Both Hall sensors have a number of adjacent sensor contacts 4.1,5.1.

It is an important aspect of the invention that connection of the Hall sensors 4,5 to plug unit 6 be conducted through a pressed screen 8,9. It is to be understood that any other unit for connection purposes of the pressed screen may be used instead of the plug unit 6. The pressed screens 8,9 are punched out from a sheet, leaving at least one connector between the individual pressed screen conductor tracks. A variety of different components, such as components 41,42 may be arranged on the pressed screens 8,9.

The pressed screen 8 is depicted in FIG. 1b. In this first variant, the individual conductor tracks of the pressed screen 8 are guided parallel to the sensor contacts 4.1,5.1. The conductor tracks of the pressed screen 8 are angled so that a V-shaped configuration is produced in the top view of the two adjacent pressed screens 8.

The pressed screen 9 is shown in FIG. 3. In this second variant, the individual conductor tracks of the pressed screen 9 are guided in series to the adjacent sensor contacts 4.1,5.1, so that an essentially U-shaped configuration of the two opposite pressed screens 9 is obtained in the top view. The lower arm of the U is divided into a connection to the sensor contacts 4.1 of the Hall sensor and an additional connection to the sensor contacts 5.1 of Hall sensor 5. The adjacent conductor tracks of the two pressed screens are then guided to the plug contact 6.

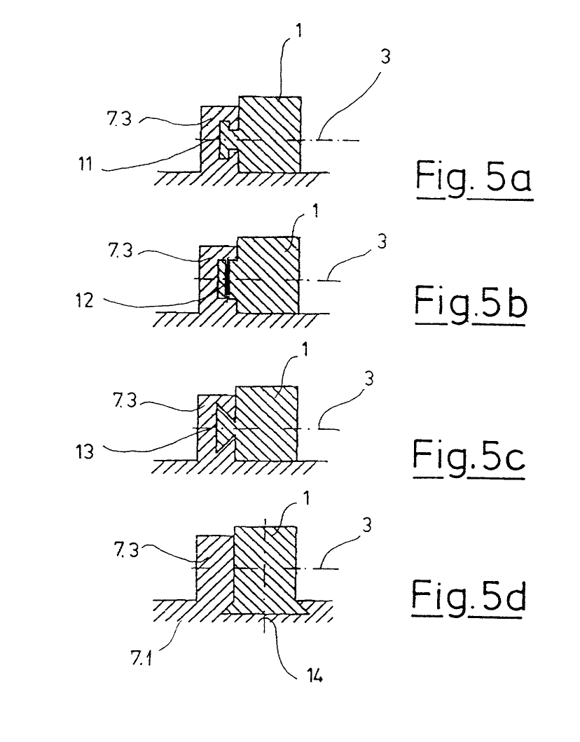

It is also an important aspect of the invention that the stator segments have a connector. In FIG. 5a, a T-side connector 11 is formed on the stator segment 1. The T-shaped side connector 11 includes an arm connector molded onto the stator segment 1, to which a transversely lying connector with comparative thickness is connected.

In FIG. 5b, an I-side connector is molded onto the stator segment 12. It consists of a connector molding into which a bead is at least partially introduced.

In FIG. 5c, a V-side connector 13 is molded on the side of the stator segment 1. The V-side connector has a dovetail configuration and is molded laterally with its dovetail onto the stator segment 1.

In FIG. 5d, the stator segment 1 is modified into a reverse V-foot connector 14. The V-foot connector is designed in cross section as a truncated pyramid.

The T-side connector 11, the I-side connector 12, the V-side connector 13 and the V-foot connector 14 follow in their configuration the pitch circle-shaped stator segment 1.

As in stator segment 1, such connectors 11 . . . 14 are also molded onto stator segment 2.

The cover element 7 is shown in FIGS. 1a, 1b and 3. The cover element 7 may be formed from a magnetically and/or electrically nonconducting material. In an example embodiment, this material may be a plastic.

In another apect of the invention, the connectors 11 . . . 14 of stator segments 1,2 and the pressed screens 8,9 and the components may be molded in during formation of cover element 7. As shown in FIGS. 5a to 5d, the connectors 11 . . . 14 of stator segments 1,2 may be molded into a cover stator wall 7.3 or into a cover wall 7.1, which are simultaneously molded with the cover element. Owing to their special configuration, the connectors 11 . . . 14 ensure that the stator segments 1,2 are secured and, above all, in the correct position. The spacer recess 3 is designed most accurately, and also true to position on this account.

A cover sensor block 7.2 is formed in the region of Hall sensors 4,5 with the cover wall. The cover sensor block 7.2 is designed higher than the cover stator wall 7.3 relative to the two Hall sensors 4,5. The cover sensor block 7.2 reaches at least to the sensor contacts 4.1, 5.1. It can either leave the sensor contacts free or be molded with them. If the sensor contacts remain free, they are available at any time for testing and control purposes. If, on the other hand, they are enclosed by the material of the cover element 7, just like the pressed screens 8, 9, they are completely shielded and insulated relative to all influences.

When the pressed screens are formed, connectors present during the forming phase of the cover element between the individual conductor tracks of pressed screens 8,9 are removed.

When the cover element 7 so equipped is finished, the housing 41 of a throttle unit may be closed with it.

The stator segments 1,2 and the pressed screens 8,9 may be formed in the housing of the throttle unit or a separate sensor housing in the same manner, instead of in cover element 7. The components may also be molded in here. The housing need only be formed partially from a magnetically and/or electrically nonconducting material, and only the part that accommodates the rotation angle sensor 100. The other parts of the housing of the throttle unit may be formed from iron or the like.

The shape and design of the pressed screens are not constrained to the shapes according to pressed screens 8, 9. The pressed screens may be punched out in the configurations for a line connection of the Hall sensors 4, 5 to a takeoff unit point for the signals, which is shown here as plug unit 6.

An alternative embodiment of a stator unit 81 of a rotation angle sensor 200 is depicted in FIGS. 6 to 8b.

The stator unit 81 includes two stator half-disks 51, 52, designed in the shape of apple segments. The stator half-disks 51, 52 leave a spacer recess 53 open between them. Each has an L-foot connector 64.

In the spacer recess 53, a Hall sensor 54 with sensor contacts 54.1 and a Hall sensor 55 with sensor contacts 55.1 are arranged.

The plug contacts 54.1, 55.1 are each connected to a pressed screen 58, 59 and lead to the plug contacts of a plug unit 56.

The rotation angle sensor has a sensor housing 57, which is also formed from an electrically and/or magnetically nonconducting material, such as plastic. During forming of the sensor housing, the stator half-disks, with their L-foot connectors 64 and the two versions 58,59 of the pressed screens, may be simultaneously molded in.

The pressed screen 58 is guided right beneath the sensor contacts. It may also be shaped like the pressed screen 8. Each sensor contact 54.1,55.1 of the Hall sensors 54,55 is connected to a conductor track of pressed screen 58.

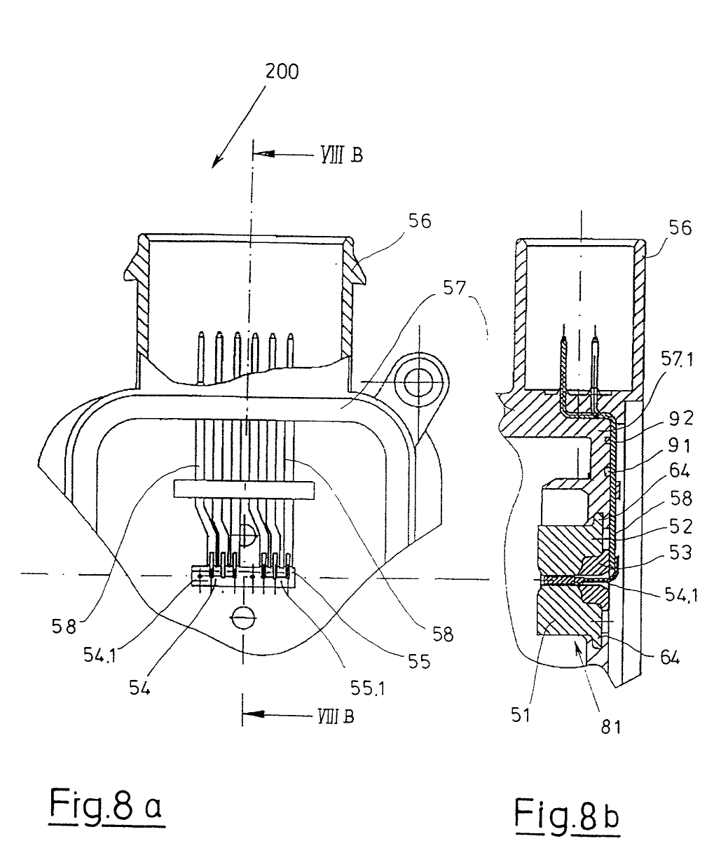

The sensor contacts 54.1,55.1 of the Hall sensors, as shown in FIGS. 8 and 9, are angled L-shaped. The pressed screen 59 is introduced to these angled sensor contacts. The pressed screen 59 is also designed straight. The pressed screens 58,59, however, depending on the corresponding use conditions, may also be designed differently, as already mentioned. Various components such as components 91,92 may also be arranged on the pressed screens 58,59.

Electrical connection of the pressed screens 58,59 to the sensor contacts 54.1,55.1 occurs as in the pressed screens 8,9 and the sensor contacts 4.1,5.1 by welding, bonding, soldering, crimping or by any other known form of connection.

During forming of sensor housing 57, the foot connector 64 of the stator half-disks 51,52 and the pressed screens 58,59, as well as the components, are molded in and secured in the correct position. The pressed screens and components are also protected from external influences.

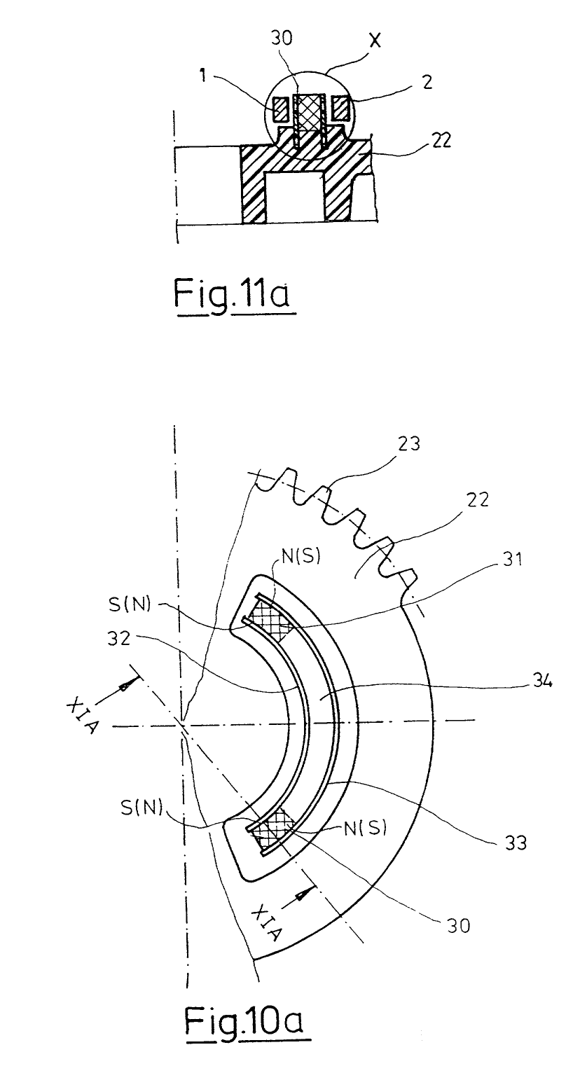

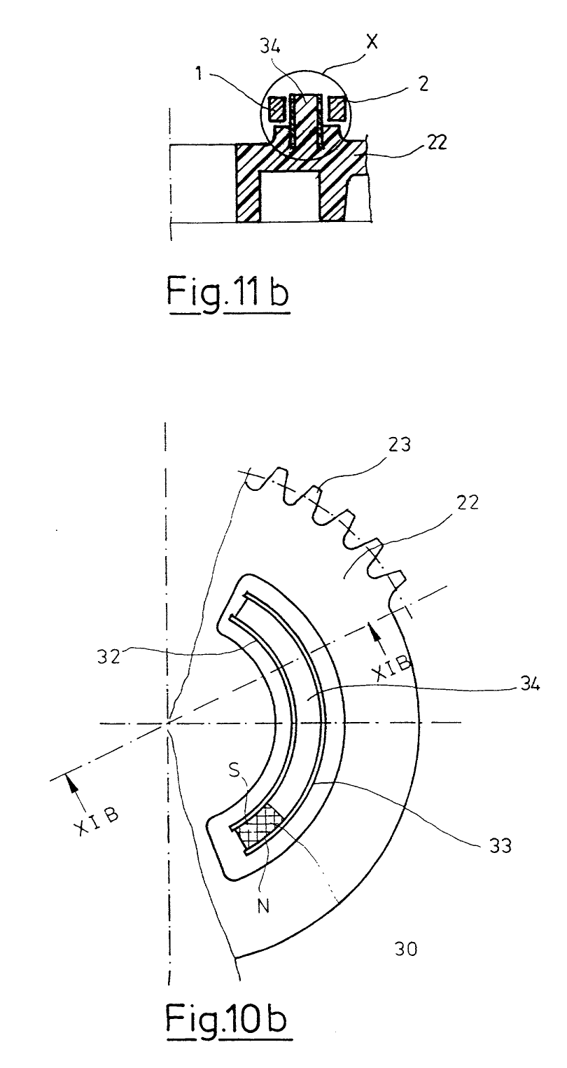

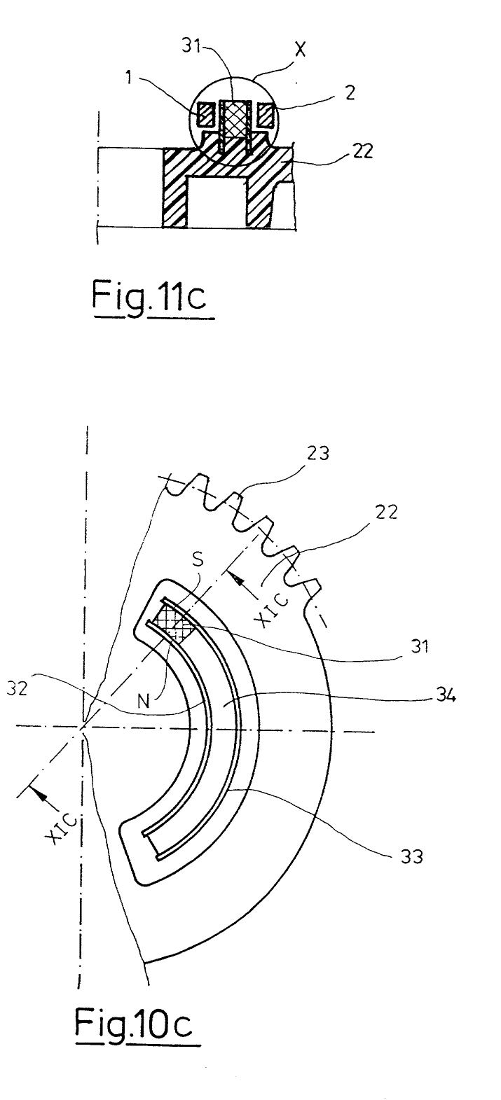

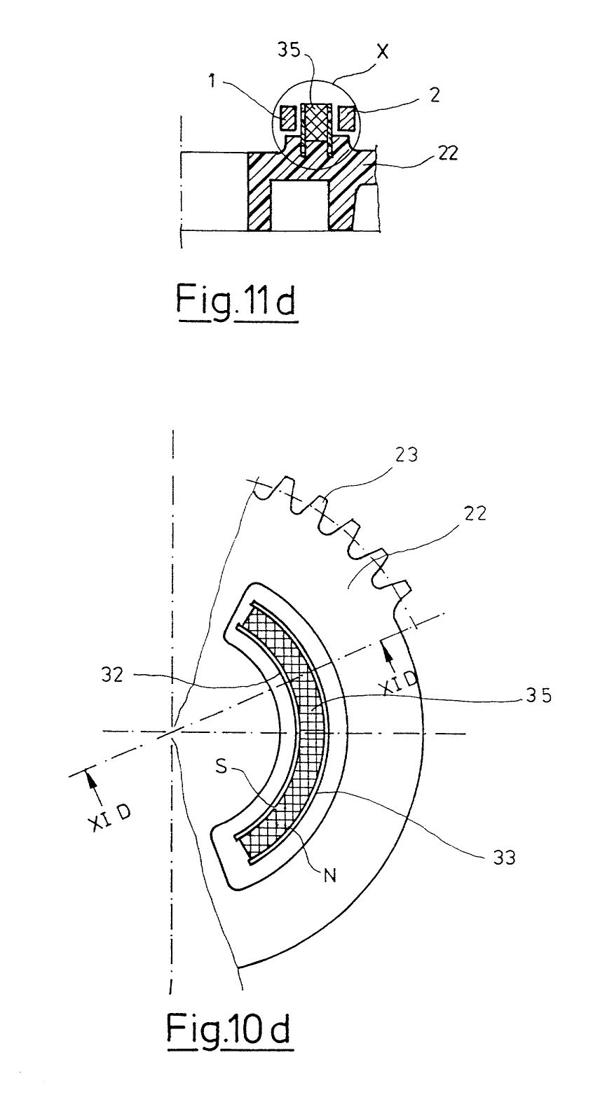

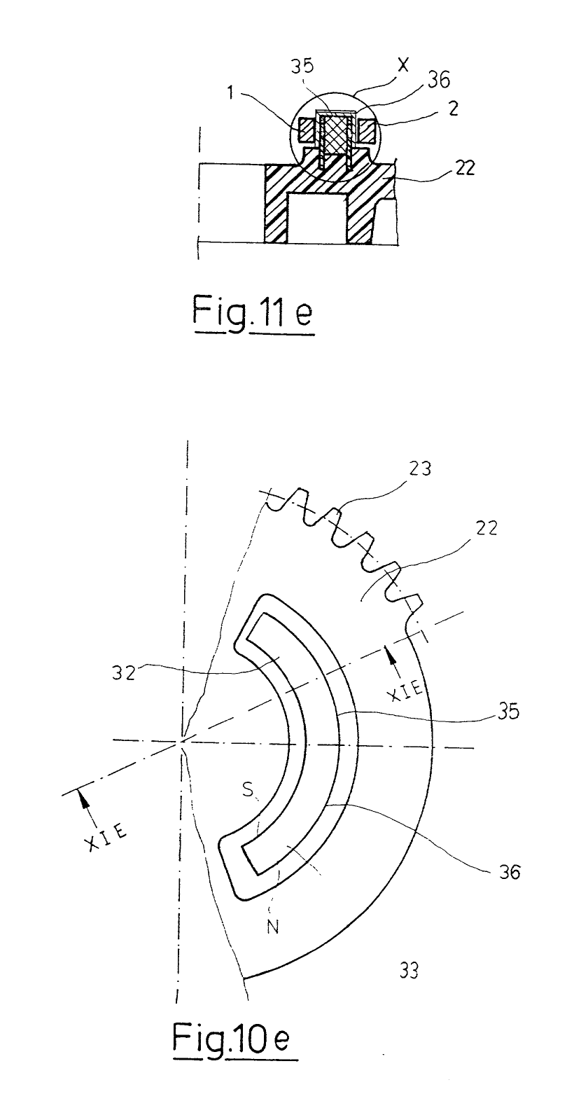

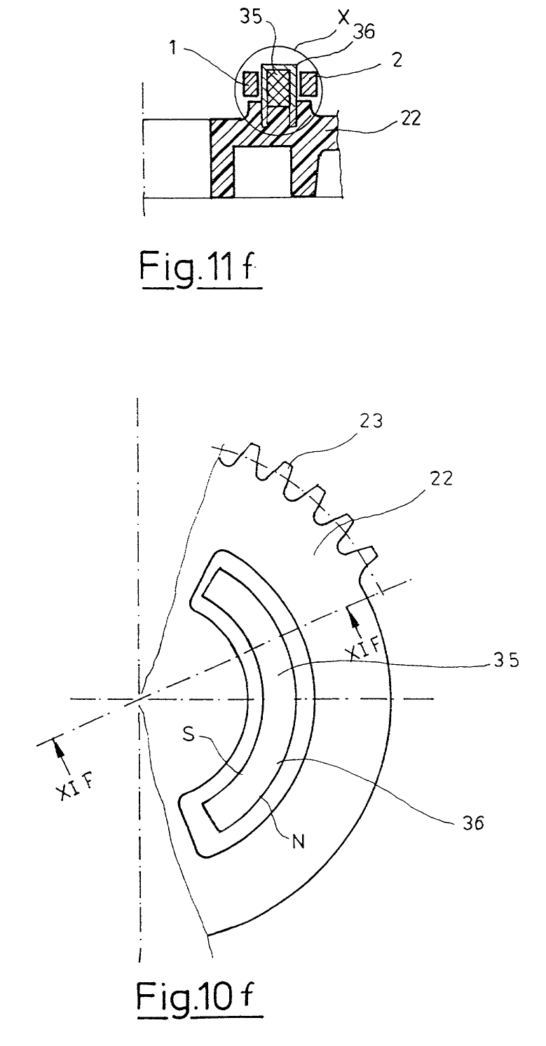

The rotor unit 22 according to FIG. 9, which is moved relative to stator unit 21 according to FIGS. 1a to 5d, is depicted in FIGS. 10a to 12f with differently designed annular magnetic part elements 70.

The rotor unit 22, as already explained, is designed here as a gear 22 of gear mechanism 45.

The gear 22, which has toothing 23, is formed from a magnetically and/or electrically nonconducting material, like plastic or the like.

The annular magnetic part element 70 may be formed as follows:

According to FIG. 10a, the magnetic element includes two magnetic segments 30,31, which are bounded on both sides by a flux conductor sheet 32,33. Its north pole N is directed toward the flux conductor sheet 33 and its south pole S toward the flux conductor sheet 32. As the S and N in parenthesis show, it may also be reversed.

During forming of gear 22, the two magnetic segments and the two flux conductor sheets may be molded in simultaneously and the free space situated between them filled in with a plastic element 34. This ensures that both magnetic segments and the flux conductor sheets 32, 33 are held in the correct position. It is of special significance that costly magnetic material is saved by this configuration. The two magnetic segments 30,31 need only be designed long enough so that they make up between about three to 15 percent of the angular length of the two flux conductor sheets. The magnetic flux from both magnetic segments, which are poled as already described, is further conveyed by the two flux conductor sheets 32, 33. The flux conductor sheets also assume a protective function, especially during transport of the sensor parts or the entire sensor 100.

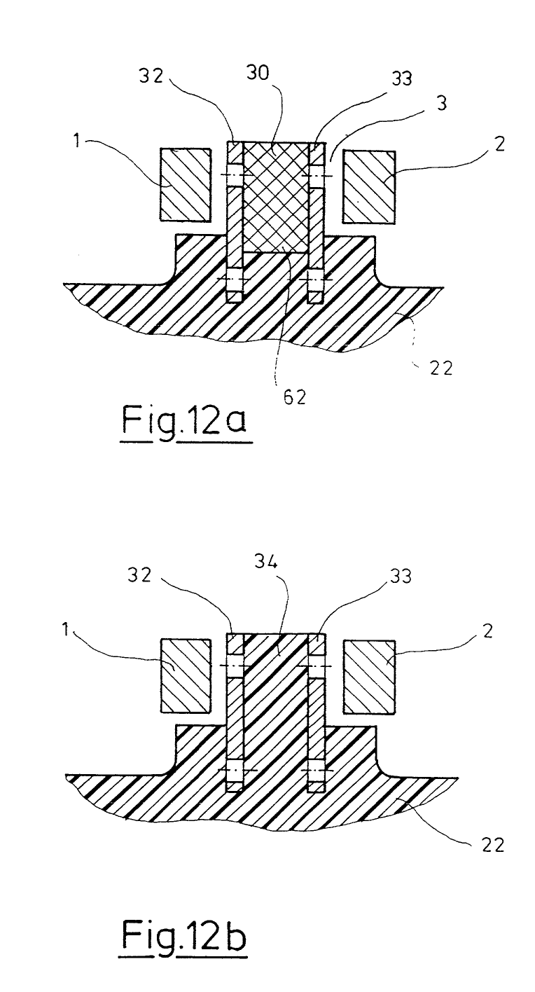

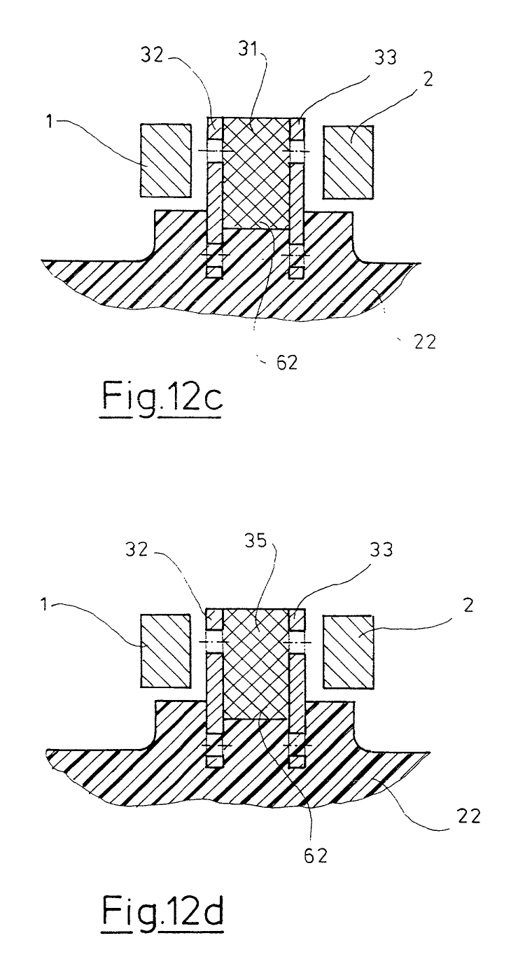

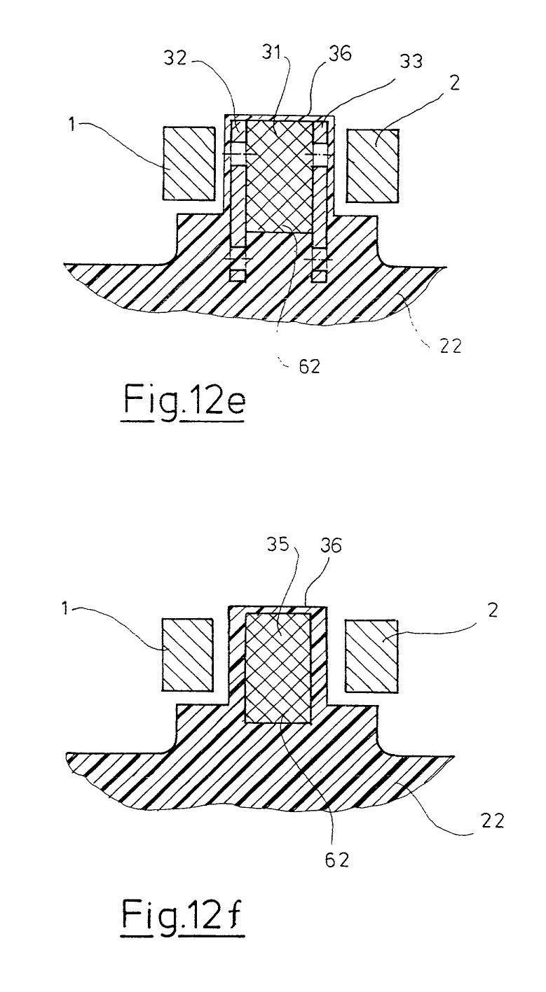

FIG. 12a shows that the magnetic segments with the two flux conductor sheets are to be moved in the spacer recess 3 between the stator segment 1 and the stator segment 2. The varying magnetic flux conducted through the stator segments 1,2 via Hall sensors 4, 5 generates output signals that are a gauge of the excursion of gear 22.

It is also apparent from FIG. 12a that the magnetic segments are held in the plastic of gear 22 by an I-side connector 62.

According to FIGS. 10b, 11b and 12b, the magnetic elements include only magnetic segment 30, on both sides of which the flux conductor sheets 32,33 are molded into the material of gear 22.

In FIG. 12b, the plastic element 34 molded between the flux conductor sheets is readily apparent. If the gear is formed from another material, the element denoted 35 consists of this material. If the material is magnetically conducting, the magnetic segment and the flux conductor sheets are molded into the insulating plastic.

According to FIGS. 10c, 11c and 12c, the magnetic elements include only magnetic segment 31, on whose sides the two flux conductor sheets are molded-in in the manner already described. Relative to magnetic segment 30, the magnetic poles are marked differently only for purposes of explanation. It is of special significance that even more magnetic material is saved by the use of only one magnetic segment.

According to FIGS. 10d, 11d and 12d, the magnetic segment includes a magnetic segment 35 that has roughly the same length as the adjacent flux conductor sheets 32,33, so that no plastic element is situated between them, as shown, in particular, in FIG. 12d. Their molding occurs in the manner already described. The flux conductor sheets here assume a protective function, in particular, for the magnetic segment.

In FIGS. 10e, 11e and 12e, the magnetic segment includes a magnetic segment 35, as in FIGS. 10d, 11d and 12d, which has the same length as the adjacent flux conductor sheets 32,33, only these are coated with a plastic outer element 36. Because of this, these parts are covered on all sides with plastic and effectively protected from outside influences.

The configurations according to FIGS. 10a, 11a and 12a, 10b, 11b and 12b, as well as 10c, 11c and 12c, may also be coated by plastic element 36 in the same manner.

In FIGS. 10f, 11f and 12f, the magnetic segment 35 is coated fully by the plastic outer element 36, which provides the already described advantages. In the same manner, the individual magnetic segments 30 and 31 without flux conductor sheets according to FIGS. 10a, 11a and 12a and FIGS. 10b, 11b and 12b may be coated in similar fashion.

While particular embodiments of the present invention have been shown and described, it will be obvious to those skilled in the art that, based upon the teachings herein, changes and modifications may be made without departing from this invention and its broader aspects and, therefore, the appended claims are to encompass within their scope all such changes and modifications as are within the true spirit and scope of this invention. Furthermore, it is to be understood that the invention is solely defined by the appended claims.

What is claimed is:

1. A rotation angle sensor for use in a throttle adjustment device, comprising:
a stator unit having at least two stator part elements, said at least two stator part elements being positioned relative to each other leaving a spacer recess therebetween;
at least one Hall sensor positioned in the spacer recess;
a rotor unit having at least one annular magnetic part element, said rotor unit being movable relative to said stator unit;
a plug unit; and
a housing unit adapted to at least partially house the stator unit, wherein said at least one annular magnetic part element has a connector element molded into the rotor unit.

2. A rotation angle sensor for use in a throttle adjustment device, comprising:
a stator unit having at least two stator part elements, said at least two stator part elements being positioned relative to each other leaving a spacer recess therebetween, each of said at least two stator part elements having a connector element;
at least one Hall sensor positioned in the spacer recess;
a rotor unit having at least one annular magnetic part element, said rotor unit being movable relative to said stator unit;
a plug unit connected to said at least one Hall sensor by a pressed screen; and
a housing unit adapted to at least partially house the stator unit, wherein at least said connector elements of said stator part elements and the pressed screen are at least partially molded into the housing element.

3. A rotation angle sensor for use in a throttle adjustment device, comprising:
a stator unit having at least two stator part elements, said at least two stator part elements being positioned relative to each other leaving a spacer recess therebetween;
at least one Hall sensor positioned in the spacer recess;
a rotor unit having at least one annular magnetic part element having a magnetic segment, said rotor unit being movable relative to said stator unit;
a plug unit; and
a housing unit in which at least said stator unit is at least partially housed, wherein said at least one annular magnetic part element has a connector element positioned with said magnetic segment in said rotor unit.

4. A rotation angle sensor for use in a throttle adjustment device, comprising:
a stator unit having at least two stator part elements, said at least two stator part elements being positioned relative to each other leaving a spacer recess therebetween;
at least one Hall sensor positioned in the spacer recess;
a rotor unit having at least one annular magnetic part element, said rotor unit being movable relative to said stator unit, said at least one annular magenetic part element having at least one magnetic segment with at least one flux conductor sheet thereon;
a plug unit; and
a housing unit in which at least the stator unit is at least partially housed.

5. A rotation angle sensor for use in a throttle adjustment device, comprising:
a stator unit having at least two stator part elements, said at least two stator part elements being positioned relative to each other leaving a spacer recess therebetween, each of said at least two stator part elements having a connector element;
at least one Hall sensor positioned in the spacer recess;
a rotor unit having at least one annular magnetic part element having at least one magnetic segment having a connector element, said rotor unit being movable relative to said stator unit; said magnetic part element being molded at least with the connector element into the rotor unit
a plug unit connected to said at least one Hall sensor by a pressed screen; and
a housing unit adapted to at least partially house the stator unit, wherein said connector elements of the stator part elements and the pressed screen are at least partially molded into the housing unit.

6. A rotation angle sensor for use in a throttle adjustment device, comprising:
a stator unit having at least two stator part elements, said at least two stator part elements being positioned relative to each other leaving a spacer recess therebetween, each of said at least two stator part elements having a connector element;
at least one Hall sensor positioned in the spacer recess;
a rotor unit having at least one annular magnetic part element, said rotor unit being movable relative to said stator unit, said at least one annular magnetic part element having at least one magnetic segment with at least one flux conductor sheet located thereon, said at least one magnetic segment and said at least one flux conductor sheet being molded at least partially into said rotor unit;
a plug unit connected to said at least one Hall sensor by a pressed screen; and
a housing unit adapted to at least partially house the stator unit, said pressed screens being at least partially molded into said housing unit.

7. A rotation angle sensor according to claim 1, wherein said annular magnetic part element comprises at least one magnetic segment.

8. A rotation angle sensor according to claim 7, further comprising a flux conductor sheet molded into the rotor unit on at least one side of at least one magnetic segment.

9. A rotation angle sensor according to claim 7, further comprising a flux conductor sheet molded into the rotor unit on both sides of two magnetic elements having a spacing therebetween.

10. A rotation angle sensor according to claim 2, wherein said stator part elements are formed in stator segments.

11. A rotation angle sensor according to claim 6, said flux conductor sheet being equal length to said at least one magnetic segment.

12. A rotation angle sensor according to claim 6, said flux conductor sheet being essentially longer than at least a second magnetic segment.

13. A rotation angle sensor according to claim 12, further comprising a mounting element molded in a space between the flux conductor sheet and the second magnetic segment.

14. A rotation angle sensor according to claim 13, wherein the first magnetic segment is at least partially enclosed by an outer element.

15. A rotation angle sensor according to claim 14, wherein the first magnetic segment or the second magnetic segment and the flux conductor sheet are at least partially enclosed by the outer element.

16. A rotation angle sensor according to claim 2, further comprising at least one component arranged on the pressed screen.

17. A rotation angle sensor according to claim 5, wherein the at least two stator part elements comprise stator half-disks in the shape of apple segments.

18. A rotation angle sensor according to claim 1, further comprising a sealing ring positioned between the rotor unit and the housing unit.

19. A rotation angle sensor according to claim 1, wherein the stator unit is at least partially a part of said housing unit and the rotor unit is at least partially a part of a gear mechanism of the throttle adjustment device.

20. A rotation angle sensor according to claim 19, wherein the drive part is a gear.

21. A rotation angle sensor according to claim 1, further comprising a of pressed screens connected in series to a plurality of sensor contacts of the at least one Hall sensor.

22. A rotation angle sensor according to claim 1, further comprising a second pressed screen connected in parallel to the sensor contacts of said at least one Hall sensor.

23. A rotation angle sensor according to claim 22, wherein said housing unit comprises a housing wall, into which the first and second pressed screens are molded, a housing sensor block which is molded with the housing wall, and housing stator walls formed with the housing wall, and in which the connector elements of the stator segments are molded.

24. A rotation angle sensor according to claim 23, further comprising a second housing unit having a housing element into which the connector elements of the stator half-disks and third and fourth pressed screens are molded.

25. A rotation angle sensor according to claim 24, wherein said at least one component is molded in with the pressed screens in the first and second housing units.

26. A rotation angle sensor according to claims 24, wherein the first and second housing units are formed at least partially from a magnetically and/or electrically nonconducting material.

27. A rotation angle sensor according to claim 24, wherein the first and second housing units comprise a cover element of a sensor housing, a housing of a sensor housing, a cover element of the throttle adjustment device or a housing of the throttle adjustment device.

28. A rotation angle sensor according to claim 23, further comprising a further stator segment connected to at least one of the two stator segments.
